(19) United States
(12) Patent Application Publication
(10) Pub. No.: US 2005/0166002 A1
(43) Pub. Date: Jul. 28, 2005

(54) Memory intrusion protection circuit

(75) Inventors: David Presley Wallace, Toney, AL (US); Jones Ephraim Allison III, Madison, AL (US); Jason David Bridges, Harvest, AL (US)

Correspondence Address: CHARLES E. WANDS;Allen Dyer Doppett Milbrath & Gilchrist PA, 1401 Citrus Center, 255 Orage Ave., P.O. Box 3791, Orlando, FL, 32802, US

(73) Assignee: ADTRAN, INC., HUNTSVILLE, AL (US)

(21) Appl. No.: 10/764,770

(22) Filed: Jan. 26, 2004

(51) Int. Cl. G06F 12/14

(52) U.S. Cl. 711/100

(57) ABSTRACT

An electronic signal processing apparatus contains a security key memory. Unless the security key memory contains a prescribed security key, a user is unable to operate the electronic signal processing apparatus. An intrusion detection and protection mechanism prevents access to the security key in the event of a compromise in the integrity of a housing for the security key memory. For this purpose, an intrusion detection circuit is adapted to monitor the integrity of the housing. A memory contents modification circuit is operative, in response to the intrusion detection circuit detecting a compromise in the integrity of the housing (opening of the housing), to modify (e.g., scramble) the contents of the security key memory and thereby effectively remove the security key from the security key memory.

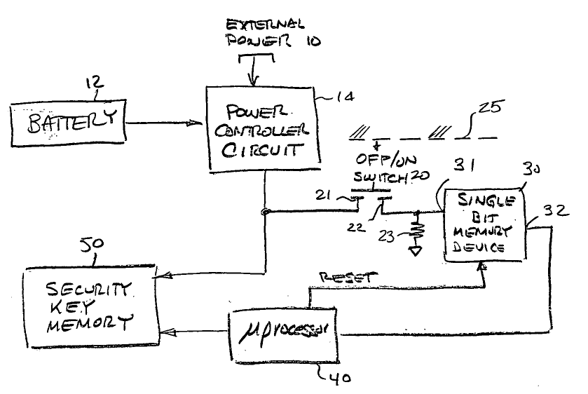

### FIELD OF THE INVENTION

The present invention relates to electronic signal processing systems and subsystems thereof, and is particularly directed to a memory intrusion detection and protection mechanism for safeguarding the information contents of memory, especially preventing access to a security key stored in the memory.

### BACKGROUND OF THE INVENTION

A variety of signal processing systems, such as but not limited to virtual private networks (VPNs), employ application programs containing security codes or keys, which must be invoked in order to successfully access and/or execute a system program. These security keys are typically stored in a memory chip installed on a printed circuit board, that has battery back-up in the event of a disconnection from the system's principal power supply. In an effort to prevent unauthorized access to the contents of such memory chips, it has been proposed to provide a switching mechanism that disconnects the battery when the system housing or case is physically opened, so that the contents of the (no-longer powered) memory will be indeterminate (random). It has been found, however, that many memory devices, especially those designed to operate at a low voltage, tend to retain their contents for some period of time, even through power has been removed. As a consequence, once power is restored, it may be expected that the memory will reacquire its previous state, so that the security information is compromised.

### SUMMARY OF THE INVENTION

In accordance with the present invention, this problem is successfully remedied by means of a single bit-based intrusion detector, that uses an OFF/ON switch as a control mechanism to monitor the physical integrity of the case or housing containing a security key memory whose contents are to be protected. If the case is open, the OFF/ON switch is open; if the case is closed, the switch is closed. The output of the OFF/ON switch is coupled to a single-bit memory device, which has its input coupled through a pull-down resistor to a logical low. The single-bit memory device is controllably reset by a microprocessor, which monitors the single bit value stored in the memory device, and is coupled to control the state of the security key memory.

In operation, as long as the system case remains physically closed, the single-bit memory device (having been reset by the processor) will store a prescribed state (e.g., a non-default state). Thereafter, if the integrity of the protective case is compromised, the OFF/ON switch will be opened. This opening of the OFF/ON switch changes the contents of the single-bit memory device (e.g., from a non-default state to a default state). This change in state is read by the processor as an intrusion. In the case that the battery is removed from the single-bit memory device in an attempt to defeat the intrusion detection, the device will register an intrusion when power is restored. In response to this intrusion, the processor scrambles the contents of the security key memory and then resets the single-bit memory device. Since the contents of the security key memory have been scrambled, then, even if the battery or power is resupplied, the security key can no longer be accessed. It must be rewritten into memory by an authorized user employing a program for the purpose.

### BRIEF DESCRIPTION OF THE DRAWINGS

The single FIGURE is a block diagram illustration of the memory intrusion detection and protection mechanism in accordance with a preferred embodiment of the present invention.

### DETAILED DESCRIPTION

Before describing the intrusion detection and protection mechanism in accordance with the present invention, it should be observed that the invention resides primarily in a modular arrangement of conventional electronic signal processing circuits and supervisory digital processing components, and associated control software therefor. In a practical implementation that facilitates their being packaged in a hardware-efficient equipment configuration, these modular arrangements may be readily implemented as field programmable gate array (FPGA), or application specific integrated circuit (ASIC) chip sets.

Consequently, the configuration of such an arrangement of circuits and components and the manner in which they are interfaced with one another have, for the most part, been illustrated in the drawings by a readily understandable block diagram, which shows only those specific details that are pertinent to the present invention, so as not to obscure the disclosure with details which will be readily apparent to those skilled in the art having the benefit of the description herein. The block diagram illustration is primarily intended to show the major components of the memory intrusion detection system of the invention in a convenient functional grouping, whereby the present invention may be more readily understood.

Attention is now directed to the single FIGURE, which is an overall block diagram of the single bit-based memory intrusion detection and protection mechanism in accordance with the present invention. As described briefly above and as shown diagrammatically in the FIGURE, each of a principal (external) power supply 10 and a battery back-up 12 are coupled to a power controller circuit 14, which is operative to supply power to the internal circuit of the housing containing the memory and associated circuitry to be described. In particular, the output of the power controller circuit 14 is coupled to the input 21 of an OFF/ON switch 20, the closure of which is dependent upon the physical integrity of the system case or housing (represented by broken lines 25) containing the memory 50 to be protected. If the case/housing is open, switch 20 is open/OFF; if the case is closed, switch 20 is closed/ON.

The output 22 of switch 20 is coupled to the input 31 of a single-bit memory device 30, which is used to latch a bit representative of an access condition of the memory case. For this purpose, the input 31 of the single bit memory device 30 is coupled through a pull-down resistor 23 to a prescribed logical low voltage (e.g., ‘0’ volts). The single-bit memory device 30 is controllably reset by a microprocessor 40, which monitors the output 32 of memory device 30. Processor 40 is coupled to control the state of the security key memory 50.

In operation, with the memory system case 25 physically closed, once reset by the processor 40, the single-bit memory device 30 will store a prescribed state (e.g., a non-default state). Thereafter, if the integrity of the case is compromised (opened), the OFF/ON switch 20 is also opened. This opening of the switch 20 causes a change in state of the contents of the memory device 30 (e.g., from a non-default state to a default state), which is read by the processor 40 as an intrusion. In accordance with the invention, in response to an intrusion indication, processor 40 is programmed to scramble the contents of the security key memory 50. Thereafter, processor 40 resets the single-bit memory device 30. Since the contents of the security key memory 50 have been scrambled as a result of the intrusion, then, even if battery or power is resupplied, the security key can no longer be accessed. It must be rewritten into the security key memory 50 by an authorized user employing a program for the purpose.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

1. For use with an electronic signal processing apparatus containing a security key memory which stores a security key that enables a user to operate said electronic signal processing apparatus, a method of preventing access to said security key in the event of a compromise in the integrity of a housing for said security key memory, said method comprising the steps of:
(a) monitoring the integrity of said housing; and
(b) in response to step (a) detecting said compromise in the integrity of said housing, changing the contents of said security key memory so as to effectively remove said security key from said security key memory.

2. The method according to claim 1, wherein step (a) comprises storing, in a single-bit storage device, a single bit representative of a prescribed power supply state of said security key memory, and changing the bit state of said single-bit storage device in response to said compromise in the integrity of said housing for said memory.

3. The method according to claim 1, wherein step (b) comprises in response to step (a) detecting a change in the bit state of said single-bit storage device, changing the contents of said security key memory so as to effectively remove said security key from said security key memory.

4. The method according to claim 1, wherein step (a) comprises coupling a switch, having a closure state dependent upon the integrity of said housing, to said single-bit storage device, and in response to said compromise in the integrity of said housing, operating said switch, so as to change the bit state of said single-bit storage device.

5. For use with an electronic signal processing apparatus containing a security key memory in which is stored a security key that enables a user to operate said electronic signal processing apparatus, an arrangement for preventing access to said security key in the event of a compromise in the integrity of a housing for said security key memory, comprising:
a single-bit storage device which is coupled to store a single bit representative of a prescribed power supply state of said security key memory;
a switch, which is coupled to said single-bit storage device, and is operative to change the bit state thereof in response to said compromise in the integrity of said housing for said memory; and
a control circuit, which is operative, in response to said change in the bit state of said single-bit storage device, to change the contents of said security key memory so as to effectively remove said security key from said security key memory.

6. In an electronic signal processing apparatus containing a security key memory, which stores a security key that enables a user to operate said electronic signal processing apparatus, an arrangement for preventing access to said security key in the event of a compromise in the integrity of a housing for said security key memory, said arrangement comprising:
an intrusion detection circuit that is adapted to monitor the integrity of said housing; and
a memory contents modification circuit that is operative, in response to said intrusion detection circuit detecting a compromise in the integrity of said housing, to modify the contents of said security key memory and thereby effectively remove said security key from said security key memory.

7. The arrangement according to claim 6, wherein said intrusion detection circuit includes a single-bit storage device that is operative to store a single bit representative of a prescribed power supply state of said security key memory, and a switch that is operative to change the bit state of said single-bit storage device in response to said compromise in the integrity of said housing for said memory.

8. The arrangement according to claim 7, wherein said memory contents modification circuit is operative, in response to a change in the bit state of said single-bit storage device, to change the contents of said security key memory so as to effectively remove said security key from said security key memory.

9. The arrangement according to claim 8, wherein said switch has a closure state dependent upon the integrity of said housing.
